(19) United States
(12) Patent Application Publication
(10) Pub. No.: US 2010/0214638 A1
(43) Pub. Date: Aug. 26, 2010

(54) METHOD AND APPARATUS FOR THREE-DIMENSIONAL TARGETING USING GALVANO MOTOR SCANNING APPARATUS

(76) Inventor: Stephen Hastings, Munchen (DE)

Correspondence Address: FRASER CLEMENS MARTIN & MILLER LLC, 28366 KENSINGTON LANE, PERRYSBURG, OH, 43551, US

(21) Appl. No.: 11/914,971

(22) PCT Filed: Aug. 6, 2007
(86) PCT No.: PCT/EP2007/058155

§ 371 Date: Nov. 20, 2007

(51) Int. Cl. G02B 26/10

(52) U.S. Cl. 359/206.1; 359/205.1

(57) ABSTRACT

This invention relates to a method of three-dimensional targeting, by galvano motor scanning head means using a combination of pre-objective and post-objective scanning techniques whereby a collimated input to collimated output beamexpander (2, 3) is used to size a beam or laser beam input into said galvano motor scanning head and a flat-field or f-Theta or telecentric lens (6) or lenses are used to focus said beam or laser beam at a target plane and where altering the separation of the elements (2, 3) within said beamexpander will alter the beam or laser beam from a collimated to a converging or diverging output into said galvano motor scanning head to alter the focal distance to said target plane.

### FIELD OF THE INVENTION

This invention relates to a method of three-dimensional targeting by galvano motor scanning head means using a combination of pre-objective and post-objective scanning techniques whereby a collimated input to collimated output beamexpander is used to size a beam or laser beam input into said galvano motor scanning head and a flat-field or f-Theta or telecentric lens or lenses are used to focus said beam or laser beam at a target plane and where altering the separation of the elements within said beamexpander will alter the beam or laser beam from a collimated to a converging or diverging output into said galvano motor scanning head to alter the focal distance to said target plane.

### BACKGROUND OF THE INVENTION

Traditional three-dimensional galvano motor scanning head targeting is achieved by either pre-objective scanning where the three-dimensional target plane is moved relative to the fixed focal distance of said galvano motor scanning head and/or by post-objective scanning where the input or expander element of a telescope is driven backwards and forwards along the beam or laser beam input axis to change the separation distance between a secondary element or secondary elements or objective lens or lenses to alter the overal focal distance of the system and therefore alter the focus in a three-dimensional area at said three-dimensional target.

### SUMMARY OF THE INVENTION

A method is provided whereby a beam or laser beam passes through a collimated input to collimated output beamexpander that may size the exiting collimated beam or laser beam aperture suitable to galvano motor driven scanning mirror apertures within a galvano motor scanning head that in turn will deflect said collimated beam or laser beam to pass through a flat-field or f-Theta or telecentric lens or flat-field or f-Theta or telecentric lenses that will in turn focus said beam or laser beam to a two-dimensional target plane.

By altering the separation distance between the input or expanding element and in this embodiment the output or collimating element of said beamexpander said beam or laser beam exiting said beamexpander will alter from collimated to converging or diverging.

The effect of altering the beam or laser beam exiting said beamexpander from collimated to converging or diverging and passing through said galvano motor driven scanning mirrors within said galvano motor scanning head that in turn will deflect said altered beam or laser beam to pass through a flat-field or f-Theta or telecentric lens or flat-field or f-Theta or telecentric lenses is that the focal length of the system will alter to allow said beam or laser beam to target to a three-dimensional target area.

By controlling the position of said input or expanding element relative to in this embodiment said output or collimating element of said beamexpander by logic means combined with controlling said galvano motor driven scanning mirrors driven by galvano motors and galvano motor drive electronics by logic means said focal length of said system may be controlled to target the focused beam or laser beam within said three-dimensional area.

### BRIEF DESCRIPTION OF THE DRAWINGS

FIG. 1 is a reference diagram depicting a typical collimated input to collimated output beamexpander layout.

FIG. 2 is a reference diagram depicting a typical collimated input to collimated output beamexpander layout where the separation distance between the input or expander element and in this embodiment a secondary or output element is increased to alter the beam or laser beam exiting said beamexpander from a collimated input to a converging output state.

FIG. 3 is a reference diagram depicting a typical collimated input to collimated output beamexpander layout where the separation distance between the input or expander element and in this embodiment a secondary or output element is decreased to alter the beam or laser beam exiting said beamexpander from a collimated input to a diverging output state.

FIG. 4 is a diagram depicting a typical collimated input to collimated output beamexpander layout where the beam or laser beam exiting said beamexpander passes to galvano motor driven scanning mirrors that in turn deflect said beam or laser beam to pass through a flat-field or f-Theta or telecentric lens to focus said beam or laser beam to a target plane and where by altering the distance between said beamexpander said target plane alters accordingly in the third or Z direction.

### DETAILED DESCRIPTION OF THE INVENTION

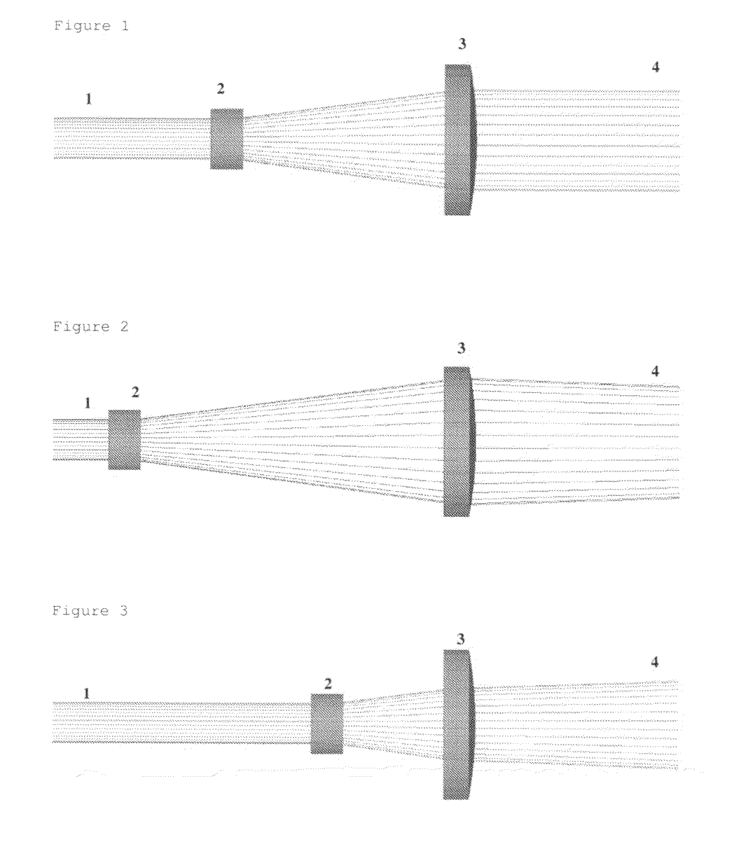

As depicted in FIG. 1 a collimated input beam or laser beam (1) enters an input or expander element (2) of a beamexpander to expand said beam or laser beam to in this embodiment a single secondary or output element (3) that when set at a given specific distance between said input or expander element (2) and in this embodiment said single secondary or output element (3) may collimate the expanded exiting beam or laser beam (4) exiting said beamexpander.

As depicted in FIG. 2 a collimated input beam or laser beam (1) enters an input or expander element (2) of a beamexpander to expand said beam or laser beam to in this embodiment a single secondary or output element (3) that when set at a greater specific distance between said input or expander element (2) and in this embodiment said single secondary or output element (3) may converge the expanded exiting beam or laser beam (4) exiting said beamexpander.

As depicted in FIG. 3 a collimated input beam or laser beam (1) enters an input or expander element (2) of a beamexpander to expand said beam or laser beam to in this embodiment a single secondary or output element (3) that when set at a lesser specific distance between said input or expander element (2) and in this embodiment said single secondary or output element (3) may diverge the expanded exiting beam or laser beam (4) exiting said beamexpander.

By driving either said input or expander element (2) and/or in this embodiment a single secondary or output element (3) along the beam or laser beam axis by driving means and by logic means the exiting beam or laser beam (4) can be altered to be either collimated, converging or diverging.

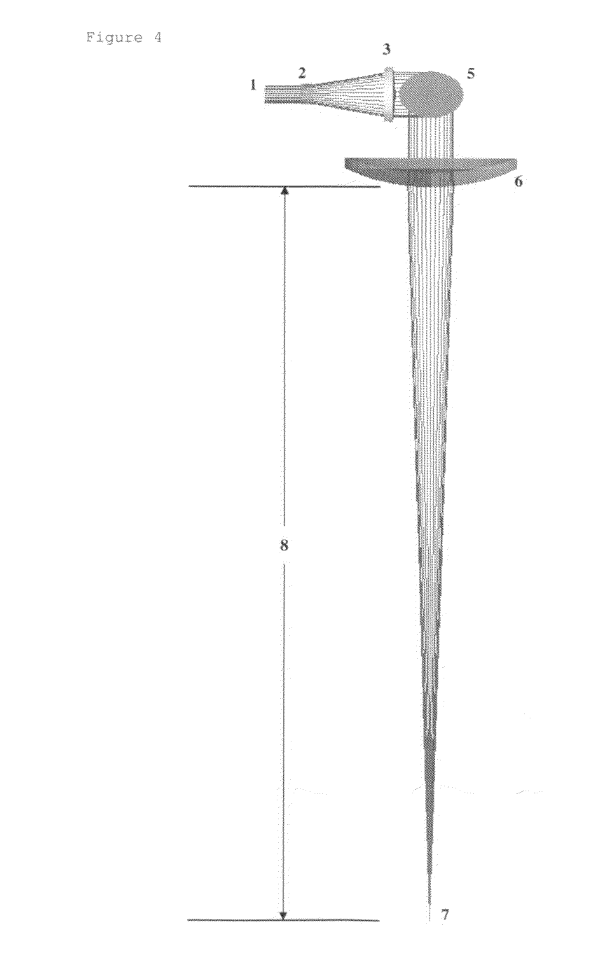

As depicted in FIG. 4, a collimated input beam or laser beam (1) enters an input or expander element (2) of a beamexpander to expand said beam or laser beam to in this embodiment a single secondary or output element (3) where the beam or laser beam exiting then passes to galvano motor driven scanning mirrors (5) that in turn deflect said beam or laser beam to pass through a flat-field or f-Theta or telecentric lens (6) to focus said beam or laser beam to a target plane (7).

By altering the separation distance between said input or expander element (2) and in this embodiment a single secondary or output element (3) along the beam or laser beam axis by driving means and by logic means the exiting beam or laser beam may be altered to be either collimated, converging or diverging and thereby altering the focal length (8) of the apparatus and position of said target plane in the third or Z direction.

The effect of altering said separation distance between said input or expander element (2) and in this embodiment a single secondary or output element (3) along the beam or laser beam axis by driving means and by logic means may shorten the focal distance (8) when said beam or laser beam exiting said beamexpander is diverging and lengthen the focal distance (8) when said beam or laser beam exiting said beamexpander is converging.

With control of the combined position or scan angles of said galvano motor driven scanning mirrors (5) driven by galvano motors (not shown) controlled by galvano motor drive electronics and by logic means in combination with control of the separation distance between said input or expander element (2) and in this embodiment a single secondary or output element (3) along the beam or laser beam axis by driving means and by logic means a three-dimensional area may be targeted.

1. (canceled)

2. (canceled)

3. (canceled)

4. (canceled)

5. (canceled)

6. A method of three-dimensional targeting, comprising the steps of:
a.) providing an input element adapted to receive a beam of light therethrough;
b.) providing an output element adapted to one of converge, diverge, and collimate the beam of light passing therethrough;
c.) providing a scanning apparatus adapted to deflect the beam of light;
d.) providing at least one lens adapted to focus the beam of light at a target plane;
e.) altering a distance between the input element and the output element to cause the beam of light to one of converge, diverge, and collimate, whereby a focal distance to the target plane is lengthened when the beam of light is converged and shortened when the beam of light is diverged; and
f.) causing the beam of light to pass through the input element, the output element, the scanning apparatus, and the at least one lens onto the target plane.

7. The method according to claim 6, wherein the beam of light entering the input element is not collimated.

8. The method according to claim 6, wherein the input element is adapted to one of increase and decrease a size of the beam of light passing therethrough.

9. The method according to claim 6, wherein the scanning apparatus uses at least one of a pre-objective and a post-objective scanning technique.

10. The method according to claim 6, wherein the scanning apparatus includes at least one galvano motor.

11. The method according to claim 6, wherein the scanning apparatus includes at least one non-galvano motor.

12. The method according to claim 6, wherein the scanning apparatus collects images from the target plane to be read by the scanning apparatus and a logic means thereof prior to the beam of light passing through the input element.

13. The method according to claim 6, wherein the at least one lens is one of a flat-field lens, an f-Theta lens, and a telecentric lens.

14. The method according to claim 6, wherein the beam of light is caused to collimate when the input element is spaced from the output element at a predetermined distance.

15. The method according to claim 14, wherein the beam of light is caused to converge when the input element is spaced from the output element at a distance greater than the predetermined distance.

16. The method according to claim 14, wherein the beam of light is caused to diverge when the input element is spaced from the output element at a distance less than the predetermined distance.

17. A method of three-dimensional targeting, comprising the steps of:
a.) providing an input element adapted to one of increase and decrease a size of a beam of light passing therethrough;
b.) providing an output element adapted to one of converge, diverge, and collimate the beam of light passing therethrough;
c.) providing a scanning apparatus adapted to deflect the beam of light, wherein the scanning apparatus includes at least one of a galvano motor and a non-galvano motor;
d.) providing at least one lens adapted to focus the beam of light at a target plane, wherein the at least one lens is one of a flat-field lens, a f-Theta lens, and a telecentric lens;
e.) altering a distance between the input element and the output element to cause the beam of light to one of converge, diverge, and collimate, wherein the beam of light is caused to collimate when the input element is spaced from the output element at a predetermined distance, wherein the beam of light is caused to converge when the input element is spaced from the output element at a distance greater than the predetermined distance, and wherein the beam of light is caused to diverge when the input element is spaced from the output element at a distance less than the predetermined distance, whereby a focal distance to the target plane is lengthened when the beam of light is converged and shortened when the beam of light is diverged; and
f.) causing the beam of light to pass through the input element, the output element, the scanning apparatus, and the at least one lens onto the target plane.

18. The method according to claim 17, wherein the beam of light entering the input element is not collimated.

19. The method according to claim 17, wherein the scanning apparatus uses at least one of a pre-objective and a post-objective scanning technique.

20. The method according to claim 17, wherein the scanning apparatus collects images from the target plane to be read by the scanning apparatus and a logic means thereof prior to the beam of light passing through the input element.

21. An apparatus for three-dimensional targeting comprising of:
an input element adapted to one of increase and decrease a size of a beam of light passing therethrough;
an output element adapted to one of converge, diverge, and collimate the beam of light passing therethrough, wherein the beam of light is caused to collimate when the input element is spaced from the output element at a predetermined distance, wherein the beam of light is caused to converge when the input element is spaced from the output element at a distance greater than the predetermined distance, and wherein the beam of light is caused to diverge when the input element is spaced from the output element at a distance at a distance less than the predetermined distance;
a scanning apparatus adapted to deflect the beam of light, wherein the scanning apparatus includes at least one of a galvano motor and a non-galvano motor; and
at least one lens adapted to focus the beam of light at a target plane, wherein the at least one lens is one of a flat-field lens, an f-Theta lens, and a telecentric lens.

22. The apparatus according to claim 21, wherein the beam of light entering the input element is not collimated.

23. The apparatus according to claim 21, wherein the scanning apparatus uses at least one of a pre-objective and a post-objective scanning technique.

24. The apparatus according to claim 21, wherein the scanning apparatus collects images from the target plane to be read by the scanning apparatus and a logic means thereof prior to the beam of light passing through the input element.

25. The apparatus according to claim 21, wherein a focal distance to the target plane is lengthened when the beam of light is converged and shortened when the beam of light is diverged.
